(19) United States
(12) Patent Application Publication
(10) Pub. No.: US 2024/0021820 A1
(43) Pub. Date: Jan. 18, 2024

(54) GRAPHENE PROCESSING TECHNIQUE

(71) Applicant: THE UNIVERSITY OF QUEENSLAND, St Lucia, Queensland (AU)

(72) Inventors: Chengzhong YU, Sinnamon Park, Queensland (AU); Xiaodan HUANG, St Lucia, Queensland (AU); Yueqi KONG, St Lucia, Queensland (AU)

(21) Appl. No.: 18/254,569

(22) PCT Filed: Nov. 25, 2021
(86) PCT No.: PCT/AU2021/051408

§ 371 Date: May 25, 2023

(30) Foreign Application Priority Data
Nov. 25, 2020 (AU) 2020904365

(51) Int. Cl. H01M 4/583; H01M 4/62; H01M 4/04; H01M 10/054

(52) U.S. Cl. CPC H01M 4/583; H01M 4/622; H01M 4/0471; H01M 10/054; H01M 4/0404; H01M 2004/021

(57) ABSTRACT

The invention relates to a method of processing graphene comprising the steps of: combining few-layer graphene with a poly(alkylene oxide); drying to form a graphene/poly(alkylene oxide) composite; and calcining the graphene/poly(alkylene oxide) composite thus formed in an inert atmosphere. The invention also relates to processed graphene comprising a few-layer feature, wherein the graphene further comprises one or more features selected from: in-plane nanopores with dimensions of from about 1.5 nm to about 3.5 nm; a greater than 50% expanded interlayer lattice; an expansion interlayer distance of greater than 3.40 Å; and an atomic O/C content of less than 4%. The invention further relates to cathodes and batteries comprising processed graphene, and the use of processed graphene in capacitive deionization or rechargeable battery applications.

### FIELD OF THE INVENTION

The present invention relates to methods of processing graphene. In particular the invention relates to methods for preparing surface-perforated graphene using mild conditions and surface-perforated graphene obtainable by these methods.

### BACKGROUND OF THE INVENTION

Graphene and its derived materials have stimulated research interests in a variety of applications, from electronics to energy storage (Nature Nanotechnology 2014, 9 (10), 725-725). One of the most important applications is the storage of intercalated ions, such as lithium, sodium, potassium and aluminium, between layered lattice planes for rechargeable batteries. Among these battery technologies, aluminium-ion batteries (AIBs) provide an attractive new-emerging battery technology due to advantages of low cost, operation safety and high gravimetric capacity of the Al anode (2980 mAh g⁻¹, 8034 mAh cm⁻³).

However, present graphene or graphitic carbon based AIB cathodes typically deliver specific capacities of only about 60 to 148 mAh g⁻¹, thus limiting the advance of AIB technology. This low specific capacity is believed to be due to the large size of the AlCl₄⁻ ion (˜5.28 Å) when intercalating into graphitic layers with a relatively small interplanar distance of 3.35 Å. The AlCl₄⁻ ions can only diffuse parallel to graphene layers through edge sites, leading to long diffusion path and an increased potential barrier from accumulated AlCl₄⁻ anions to subsequent ion intercalation.

Current approaches to expand the interlayer spacing of graphene include heteroatom doping (e.g. oxygen, nitrogen, sulphur). In addition, reducing graphene thickness to endure structural stress and lower intercalation energy barrier has been theoretically predicted as a promising strategy to increase the diffusivity of AlCl₄⁻ ions. However, these strategies do not create more intercalation sites, particularly sites suitable for AlCl₄⁻ ions. Creating in-plane nanopores in otherwise impermeable graphene planes represents another strategy to weaken the interaction between adjacent layers and enable new intercalation sites, either by physical or chemical approaches. Physical methods including plasma etching, focused ion/electron beam irradiation and oxidative etching have been applied to perforate graphene for controlling the transport of gas and liquid molecules. Plasma etching has been adopted to treat graphene foams for improving AlCl₄⁻ ion transport and capacity has been shown to deliver specific capacities of only about 148 mAh g⁻¹ at 2 Åg⁻¹. However, physical methods have the disadvantage of creating only moderate amounts of nanopores and also introduce oxygen groups. Chemical methods using oxidation or alkaline agents can also etch graphene, but these can introduce oxygen-containing groups with negative charge that provide a barrier for AlCl₄⁻ anion transportation which is undesirable for AIB applications. Oxygen groups can be eliminated using thermal reduction, but high temperature annealing induces re-graphitization of the expanded layered structures. It remains a challenge to synthesize graphene materials with the desirable properties of in-plane nanopores, expanded interlayer spacing or low oxygen content for high-performance AlCl₄⁻ ion storage.

There is a need for improved forms of graphitic carbon that addresses one or more of the problems of existing forms of graphite.

### SUMMARY OF THE INVENTION

The present inventors have developed a new surfactant-assisted thermal reductive perforation (TRP) process to modify graphene. More specifically, the surfactant is a poly(alkylene oxide). This perforation process produces graphene in a novel form that addresses one or more of the disadvantages of known graphene materials.

The inventors have discovered that a thermal reductive perforation (TRP) process using a source of free radicals can be used to convert few-layer graphene nanosheets to surface-perforated graphene (SPG) materials under conditions using relatively mild temperatures (about 400° C.).

Graphene and reduced graphene oxide are understood to adsorb free radicals, both chemically and physically. In accordance with the present invention, the use of a source of free radicals that generates both oxygen and carbon free radicals has been found to be particularly advantageous. In particular, poly(alkylene oxide) surfactant materials have been identified as a suitable source of both oxygen and carbon free radicals. Thus, the use of a TRP process involving thermal decomposition of poly(alkylene oxide) polymers, copolymers or block copolymers may be used to surface-perforate graphene. It is understood that the present process generates both oxygen-end and carbon-end free radicals. The free radicals are believed to act as “scissors” to cleave graphene C—C bonds and deplete oxygen simultaneously.

Thus, in the TRP processes described herein, the free radicals perforate the graphene surface to generate in-plane mesopores and also deplete oxygen. The resulting SPG material has a few-layer feature; a greater than 50% expanded interlayer lattice; and a low oxygen content comparable to graphene annealed at a high temperature of about 3000° C.

When employed as an AIB cathode, in some embodiments, the few-layer SPG material as prepared and described herein has been found to deliver a reversible capacity of 197 mAh g⁻¹ at current density of 2 Åg⁻¹ with a rate performance of 149 mAh g⁻¹ at 5 Åg⁻¹. This is superior to previously reported AIB cathode materials and close to, for example about 92%, of the theoretical capacity of graphene predicted by first-principle based density-functional theory (DFT). Long-term cycling over 1000 rounds at high current rates of 5 and 7 Åg⁻¹, delivering high reversible capacities of 149 and 138 mAh g⁻¹, respectively, demonstrates the potential of this technology for engineering 2D materials for electrochemical applications.

The high capacity of a cathode comprising SPG of the present invention is believed to be attributable to one or more features of the SPG. For example, in an AIB, the in-plane nanopores of the SPG cathode may provide more accessible sites for AlCl₄⁻ storage. The partially expanded lattice structure may serve to decrease the AlCl₄⁻ ion diffusion barrier. The low oxygen content may eliminate surface adsorption behavior, and the layer feature permits high utilization of interlayer spaces.

Accordingly, in a first aspect there is provided a method of processing graphene comprising the steps of:
combining few-layer graphene with a poly(alkylene oxide);
drying to form a graphene/poly(alkylene oxide) composite; and
calcining the graphene/poly(alkylene oxide) composite thus formed in an inert atmosphere.

It will be understood that the few-layer graphene starting material or precursor may be referred to herein as pristine graphene. In some embodiments, the few-layer graphene is in the form of nanosheets, preferably formed by electrochemical exfoliation, liquid-phase exfoliation, mechanical exfoliation or oxidative exfoliation. In some embodiments, the few-layer graphene is three-layer graphene, also referred to herein as G3.

In some embodiments, the calcining temperature is preferably about 400° C. Preferably, calcining is performed under an argon atmosphere.

In some embodiments, the poly(alkylene oxide) is a block co-polymer, such as a poloxamer. In some embodiments, the poly(alkylene oxide) is a P 407 poloxamer.

Calcining of the graphene/poly(alkylene oxide) composite provides surface-perforated graphene. Thus, the processed graphene prepared in accordance with the methods described herein is surface-perforated graphene (SPG). The present inventors have discovered that SPG prepared in accordance with the methods of the present invention demonstrates novel features and advantageous properties. In another aspect, there is provided processed graphene, preferably surface-perforated graphene, produced by, obtained by or obtainable by a process as described herein.

In yet another aspect, there is provided surface-perforated graphene comprising a few-layer feature, preferably a three-layer feature, wherein the graphene further comprises one or more features selected from:
in-plane nanopores with dimensions of from about 1.5 nm to about 3.5 nm;
a greater than 50% expanded interlayer lattice;
an expansion interlayer distance of greater than 3.40 Å; and
an atomic O/C content of less than 4%.

There is also provided surface perforated graphene comprising a three-layer feature, wherein the graphene further comprises two or more features selected from:
in-plane nanopores with dimensions of from about 1.5 nm to about 3.5 nm;
a greater than 50% expanded interlayer lattice;
an expansion interlayer distance of greater than 3.40 Å;
an atomic O/C content of less than 4%; and
an XRD profile demonstrating two shoulder peaks at less than 26.0°2θ.

In another aspect, there is provided surface-perforated graphene characterized in that the X-ray diffraction profile demonstrates at least one shoulder peak, preferably two shoulder peaks, at less than 26.0°2θ. Preferably the XRD profile demonstrates two shoulder peaks at less than 26.0°2θ with a greater than 20% areal ratio. In some embodiments, the XRD profile comprises two shoulder peaks at about 25.74 and about 24.75°2θ±0.2°2θ in addition to the main peak at 26.6±0.2°2θ.

The surface-perforated graphene described herein has advantageous properties and finds utility, for example, in the manufacture of cathodes. Thus, in another aspect, there is provided a cathode comprising a carbon material including processed graphene such as surface-perforated graphene as described herein, or processed graphene such as surface-perforated graphene prepared by a process as described herein. In some embodiments, the cathode comprises a carbon material comprising processed graphene as described herein, or processed graphene prepared by a process as described herein, a binder and a cathode substrate.

In some embodiments, the cathode substrate is selected from carbon cloth, carbon paper, molybdenum foil and titanium foil. In some embodiments, the binder is selected from carboxymethyl cellulose, polyvinylidene fluoride, polyvinylidene difluoride, polytetrafluoroethylene and polystyrene.

In some embodiments, the cathode further comprises a surfactant, emulsifier or dispersant. In some embodiments, the surfactant, emulsifier or dispersant comprises a hydrophilic non-ionic surfactant, such as a poloxamer.

In some embodiments, the cathode comprises one or more further carbon materials in addition to the processed graphene as described herein, or processed graphene prepared by a process as described herein. In some embodiments, the one or more further carbon materials is selected from graphene from gas, graphene from graphite, graphene oxide from graphite, graphite, modified carbon and carbon black.

In some embodiments, one or more of the carbon materials is present in the form of carbon flakes having a thickness of from about 1 nanometer to about 30 micrometers.

In one aspect, there is provided a process for preparing a cathode according to the above aspect, comprising: mixing one or more carbon materials including processed graphene as described herein, or processed graphene prepared by a process as described herein, with a binder, a solvent and optionally a surfactant, emulsifier or dispersant; applying the mixture to a cathode substrate; and drying the mixture to remove the solvent. In some embodiments, the solvent is selected from N-methyl-2-pyrrolidone, water, dihydrolevoglucosenone, one or more hydrocarbon solvents, and surfactant emulsions.

According to a further aspect, provided herein is a cathode obtained by the process according to the above aspect.

In yet another aspect, there is provided a rechargeable battery comprising processed graphene such as surface-perforated graphene as described herein, or prepared by a process as described herein, or comprising a cathode as described herein.

In a further aspect, there is provided an aluminium-ion battery comprising processed graphene such as surface-perforated graphene as described herein, or prepared by a process as described herein, or comprising a cathode as described herein.

In some embodiments, the battery further comprises an anode, wherein the anode comprises aluminium foil.

In some embodiments, the battery further comprises one or more electrolytes, wherein the one or more electrolytes comprise 1-ethyl-3⁻ methylimidazolium chloride-aluminum chloride ([EMIm]Cl—AlCl₃); urea-AlCl₃; aluminum trifluoromethanesulfonate; (Al[TfO]₃)/N-methylacetamide/urea; AlCl₃/acetamide; AlCl₃/N-methylurea; AlCl₃/1,3-dimethylurea; bistriflimide, systematically known as bis(trifluoromethane)sulfonylimide (or ‘imidate’) and colloquially as TFSI; and/or trifluoromethanesulfonate.

In some embodiments, the battery further comprises a separator, wherein the separator comprises a material selected from glass fibre, polytetrafluoroethylene or any synthetic fluoropolymer of tetrafluoroethylene, cellulose membrane and poly acrylonitrile.

In a yet further aspect, there is provided a use of processed graphene as described herein in a capacitive deionization application or in a rechargeable battery application.

### BRIEF DESCRIPTION OF THE DRAWINGS

FIG. 1. Structural characterizations of SPG materials. (a) HRTEM image of the typical spacings in SPG3-400. The inset is a low magnification TEM image of SPG3-400. (b) Wide-angle XRD patterns of SPG materials. (c) Calculated graphitic domain ratios from XRD patterns and O/C atomic ratios from XPS analysis. (d) Raman spectra and (e) N₂ sorption isotherms and pore size distributions (inset) of SPG materials. (f) The estimated nanopore (˜2.3 nm) volumes and defect densities from N₂ sorption analyses and Raman spectra. (g) Dark-field TEM image of SPG3-400. Aberration corrected TEM images of (h) SPG3-400 and (i) G3-400.

FIG. 2. Formation mechanism study and the theoretical simulations. AFM images and corresponding thickness of G3/F127 composite (a, c) and G3 (b, d). (e) SAXS patterns of G3/F127 composite and pure F127. (f) TGA profiles of G3/F127 composite, G3 and pure F127 under argon. (g) The geometry and (h) side view of bilayer graphene model with surface perforation for DFT simulation. (i) Lattice spacing expansion ratio at different positions as indicated in (h). (j) Formation energies of (AlCl₄⁻)ₓ-G, x=1, 2, 3, 4. (k) Top view of three separated layers of (AlCl₄⁻)₃-G, the numbers in brackets represent the number of carbon atoms, of which the electron cloud is overlapped with AlCl₄⁻ anions.

FIG. 3. Cathode performance of SPG materials. (a) Typical charge-discharge profiles, (b) long cycling discharge capacities and coulombic efficiencies of SPG3-400, SPG7-400 and G3-400 at 2 Åg⁻¹. (c) Charge-discharge curves of SPG3-400 at 1^{st}, 10^{th}, 50^{th}, 100^{th} and 200^{th} cycles. (d) Typical charge-discharge profiles, (e) long cycling capacities and coulombic efficiencies of SPG3-400 at 5 and 7 Åg⁻¹.

FIG. 4. Electrochemical analyses of SPG cathodes. (a) CV curves of SPG3-400 recorded at scan rate of 5, 10, 20, 50 mV s⁻¹. (b) The log (i)-log(v) plots of both anodic and cathodic peaks and their linear fitting results. (c) Contribution proportion of diffusion and capacitive processes of G3-400, SPG3-400 and SPG7-400 cathodes at 5 mV s⁻¹. (d) Ex-situ Raman spectra of G3-400, SPG3-400 and SPG3-700 at different status: \textcircled{1} pristine, \textcircled{2} fully charged and \textcircled{3} fully discharged. (e) Schematic illustration for the advantage of SPG3-400 for AlCl₄⁻ anion storage over G3⁻ and SPG7-400.

FIG. 5. The corresponding line-scan intensity profiles of lattice fringes indicated in FIG. 1a. Comparing to the intact three-layer graphene spot (Q) with an interlayer spacing distance of 3.35 Å, regions (@®) with expanded interlayer spacings of ˜3.50-3.60 Å were observed.

FIG. 6. Wide-angle XRD patterns of G7-400.

FIG. 7. Raman spectra of G7-400.

FIG. 8. Cathode performances of control materials. (a) Typical charge-discharge profiles, (b) long cycling capacities and coulombic efficiencies of G7-400 at 2 Åg⁻¹. (c) Long cycling discharge capacities and coulombic efficiencies for G3-400, G7-400 and SPG7-400 at 5 Åg⁻¹.

### DETAILED DESCRIPTION OF THE INVENTION

### Definitions

Unless defined otherwise, all technical and scientific terms used herein have the same meaning as commonly understood by those of ordinary skill in the art to which the invention belongs. Although any methods and materials similar or equivalent to those described herein can be used in the practice or testing of the present invention, preferred methods and materials are described. For the purposes of the present invention, the following terms are defined below.

The articles “a” and “an” are used herein to refer to one or to more than one (i.e. to at least one) of the grammatical object of the article. By way of example, “an element” means one element or more than one element.

By “about” is meant a quantity, level, value, number, frequency, percentage, dimension, size, amount, weight or length that varies by as much as 10, 9, 8, 7, 6, 5, 4, 3, 2 or 1% to a reference quantity, level, value, number, frequency, percentage, dimension, size, amount, weight or length. The term “approximately” is construed similarly.

When used herein the terms “w/w %”, “w/v %” and “v/v %” mean, respectively, weight to weight, weight to volume, and volume to volume percentages.

As used herein, the term “and/or” refers to and encompasses any and all possible combinations of one or more of the associated listed items, as well as the lack of combinations when interpreted in the alternative (or).

Throughout this specification and the claims which follow, unless the context requires otherwise, the word “comprise”, and variations such as “comprises” and “comprising”, will be understood to imply the inclusion of a stated integer or step or group of integers or steps but not the exclusion of any other integer or step or group of integers or steps. Thus, the use of the term “comprising” and the like indicates that the listed integers are required or mandatory, but that other integers are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements.

Each embodiment described herein is to be applied mutatis mutandis to each and every embodiment unless specifically stated otherwise.

### Abbreviations

As used herein the symbols and conventions used in these processes, schemes and examples are consistent with those used in the contemporary scientific literature, for example, the Journal of the American Chemical Society. Specifically the following abbreviations may be used in the specification: AIBs (Aluminium-ion batteries); GC (Graphitic carbon); SPG (surface-perforated graphene); TEM (transmission electron microscopy); TRP (thermal reductive perforation); XRD (X-ray diffraction).

### Methods of the Invention

The inventors have discovered that the present method for processing graphene creates holes in the top and bottom surfaces of graphene under mild conditions. Without wishing to be bound by theory, the present inventors believe that by thermally perforating surface carbon atoms, nanoporous defects are created. Consequently, the π-π interaction between adjacent graphene layers is weakened, leading to an expanded interlayer distance. These factors thus provide processed graphene with advantageous properties. Thus, when the surface-perforated graphene is employed as a cathode in an aluminium-ion battery (AIB), it is believed that the perforations facilitate the intercalation/de-intercalation of AlCl₄⁻¹ ons. Moreover, the nanosized “holes” enable new intercalation sites for AlCl₄⁻ ions from a perpendicular direction. Both the weakened interlayer interaction and the in-plane surface intercalation sites promote the AlCl₄⁻ ion storage capability of graphene materials. A cathode formed from perforated graphene when tested in an AIB was found to exhibit an excellent reversible capacity (197 mAh g⁻¹ at 2 Åg⁻¹) and a good high-rate performance (149 mAh g⁻¹ at 5 Åg⁻¹), surpassing the performance of previously reported AIBs using graphitic carbon cathodes.

According to a first aspect, the present invention provides a process for preparing perforated graphene comprising the steps of:
combining few-layer graphene with a poly(alkylene oxide);
drying to form a few-layer graphene/poly(alkylene oxide) composite; and
calcining the composite thus formed, preferably at about 300° C. to about 500° C., or at about 400° C., in an inert atmosphere.

In preferred embodiments, the perforated graphene is surface-perforated graphene (SPG).

When used herein, “graphene” refers to the allotrope of carbon consisting of a monolayer of carbon atoms bound in a hexagonal honeycomb lattice forming a plane of sp2⁻ bonded atoms with a bond length of 0.142 nanometers. Layers of graphene form graphite, the graphene layers being held together by van der Waals forces. Graphene may be prepared by several methods well known in the art and described herein. These methods generally provide graphene by overcoming the van der Waals forces by exfoliating the separate layers of graphene. In some embodiments, graphene used in the methods described herein is prepared by electrochemical exfoliation, liquid-phase exfoliation, mechanical exfoliation or oxidative exfoliation. In preferred embodiments, graphene used in the methods described herein is prepared by electrochemical exfoliation.

The pristine graphene used as the starting material in the methods is referred to as “few-layer” graphene. Preferably, few-layer graphene is in the form of nanosheets. Typically, few-layer graphene is two to nine layers thick, preferably it is two to five layers thick, more preferably two to four layers, or three layers thick. It will be appreciated that a mixture of graphene thicknesses may be present in an embodiment of the invention. In preferred embodiments, the graphene is comprised mainly of three-layer graphene and is referred to as “G3”.

When used herein, the term poly(alkylene oxide) encompasses, but is not limited to, poly(ethylene oxide), also known as poly(ethylene glycol), poly(oxyethylene), PEG or PEO; and poly(propylene oxide), also known as PPO, or poly(oxypropylene); or poly (butylene oxide). In some embodiments, preferably the weight of the polymer is from about 1000 to about 17000.

In some embodiments, the poly(alkylene oxide) forms a co-polymer. In some embodiments the co-polymer is a block co-polymer. Examples of poly(alkylene oxide) block co-polymers include poloxamers. Poloxamers generally find application as nonionic surfactants. They comprise a synthetic triblock copolymer with an A-B-A structure. The triblock copolymer is composed of a central hydrophobic chain (B) of poly(propylene oxide) (PEO) flanked by two hydrophilic chains (A) of poly(ethyleneoxide) (PEO) and may be represented by the generic structure:

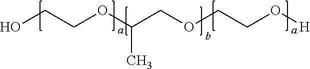

wherein:
a is an integer from 2-130; and
b is an integer from 15 to 70.

It will be appreciated that the lengths of the polymer blocks can vary, and the resulting poloxamers will have differing properties. These generic copolymers are commonly named with the letter P followed by three digits. The first two digits multiplied by 100 give the approximate molecular mass of the poly(propylene oxide) core, and the last digit multiplied by 10 gives the percentage poly(ethylene oxide) content. Thus 127 would have a polypropylene oxide mass of 1200 gmol⁻¹ and a 70% poly(ethylene oxide) content. F127 may also be represented as EO₁₀₆PO₇₀EO₁₀₆. Poloxamers are commercially available from manufacturers such as Croda or BASF Corporation and may be referred to by trade names such as Pluronic™, Synperonics™ and Kolliphor™. Pluronic and Synperonic trade names generally include a letter indicating the physical form of the poloxamer at room temperature, for example L=liquid, P=paste, F=flake (solid), followed by two or three digits. The first digit, or two digits in a three-digit number, multiplied by 300, indicates the approximate weight of the hydrophobic portion and the last digit multiplied by 10 gives the percentage poly(ethylene oxide) content.

In some preferred embodiments, the poloxamer is P 407 having a hydrophobic (PEO) portion of about 4,000 and a percentage PEO of about 70%. This poloxamer is also known by the trade names of Kolliphor™ P 407 or pluronic F127. Pluronic F127 is available from BASF Corporation. This has a hydrophobic (PEO) portion of about 3,600 and a percentage PEO of about 70%. For use in the methods described herein, Pluronic F127 is preferably dissolved in deionized water.

It will be appreciated that the physical form of the poly(alkylene oxide) will depend on its molecular formula. In some embodiments, the skilled person will understand that the poly(alkylene oxide) is preferably used in the form of a solution. Any solvent that will dissolve the poly(alkylene oxide), and will not be deleterious to the graphene, can be used. In some preferred embodiments, the solvent is water. In some embodiments, the poly(alkylene oxide) is an aqueous solution of a poloxamer, for example a solution in deionized water.

The amount and concentration of the poly(alkylene oxide) used in the methods of the invention will depend on the circumstances and the person skilled in the art will be able to determine the amounts and concentrations in accordance with their knowledge and without undue experimentation. Exemplary processes are described in the Examples below.

The ratio of graphene to poly(alkylene oxide) in the processes of the invention may be determined by the skilled person without inventive input. In some embodiments, the molar ratio of graphene to poly(alkylene oxide) is from about 350:1 to about 1750:1, wherein the molecular weight of graphene is taken as that of carbon (i.e., 12.011 g/mol).

The graphene and poly(alkylene oxide) may be combined by mixing using well known techniques. In some embodiments, preferably a mixture of graphene nanosheets and poly(alkylene oxide), preferably in de-ionised water, is mixed by sonication to obtain a suspension.

After the graphene and poly(alkylene oxide) have been combined and allowed to dry, a coating of poly(alkylene oxide) remains on the graphene surface thus providing a graphene/poly(alkylene oxide) composite. It is believed that, on drying, poly(alkylene oxide) micelles are adsorbed onto the graphene surfaces to form a composite. Although drying may be carried out at elevated temperatures, or under reduced pressure, the graphene/poly(alkylene oxide) composite is suitably dried under ambient conditions of temperature and pressure. For example, the suspension is suitably allowed to stand at room temperature to allow the solvent to evaporate.

After allowing to dry, the dried graphene/poly(alkylene oxide) composite is calcined. Preferably the calcination is performed under an inert atmosphere, such as under nitrogen or argon. Preferably calcination of the graphene/poly(alkylene oxide) composite is carried out under argon. The calcination temperature will depend on the nature of the graphene/poly(alkylene oxide) composite. Typically the graphene/poly(alkylene oxide) composite is calcined at a temperature of about 300° C. to about 800° C., for example about 300° C. to about 500° C., for example about 400° C. A typical heating rate is about 2° C. min⁻¹, preferably under argon flow.

G3 nanosheets, after undergoing thermal reductive perforation in accordance with the methods described herein, provide surface perforated graphene, referred to herein as “SPG3”. The term “SPG3-400” indicates that calcination was carried out at about 400° C. Similarly, calcining G3 at 500° C. or 600° C. provides SPG3-500 or SPG3-600. Correspondingly, G4, G5, G6, G7 or G8 may be converted to SPG4-400, SPG5-400, SPG6-400, SPG7-400 or SPG8-400 in accordance with the methods described herein.

In a preferred embodiment, there is provided a process for preparing surface perforated graphene comprising the steps of:
combining few-layer graphene nanosheets with a poloxamer;
mixing by sonication;
air drying at ambient temperature to provide a graphene/poloxamer composite; and
calcining the composite thus formed at about 400° C. under an inert atmosphere.

In some embodiments, the graphene is three-layer graphene nanosheets. In some embodiments, preferably the poloxamer is a P 407 poloxamer, for example, Pluronic F127. Depending on the nature of the poloxamer used, preferably the graphene and poloxamer are combined in the presence of a solvent such as de-ionised water. Preferably, calcining of the composite is carried out under an argon atmosphere.

The reactions and processes described herein may employ conventional laboratory techniques known in the art for mixing, heating and drying. Use of inert atmospheric conditions such as nitrogen or argon may be employed. Conventional methods of isolation of the desired compound, such as filtration techniques, and the like, may be used. Organic solvents or solutions may be dried where required using standard, well-known techniques.

### Compositions of the Invention

The surface-perforated graphene produced by the processes described herein has been found to have novel characteristic features and advantageous properties. In a further aspect, the present invention provides a surface-perforated graphene prepared by, obtained by or obtainable by a process as described herein.

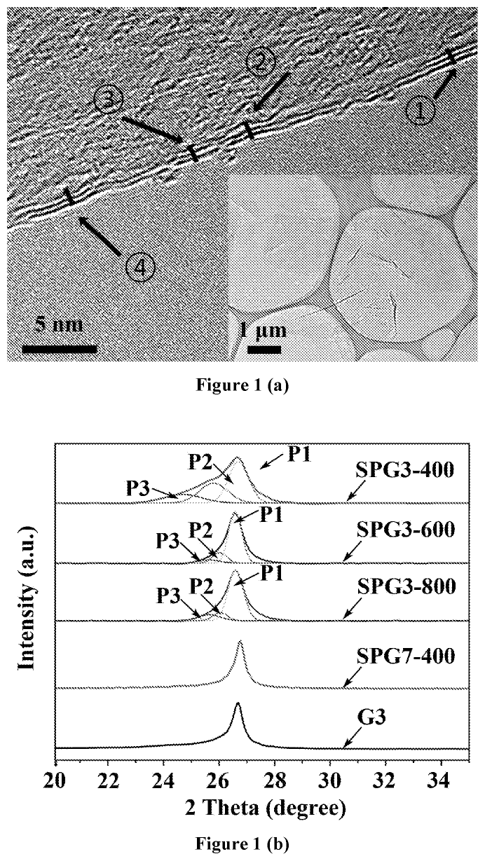

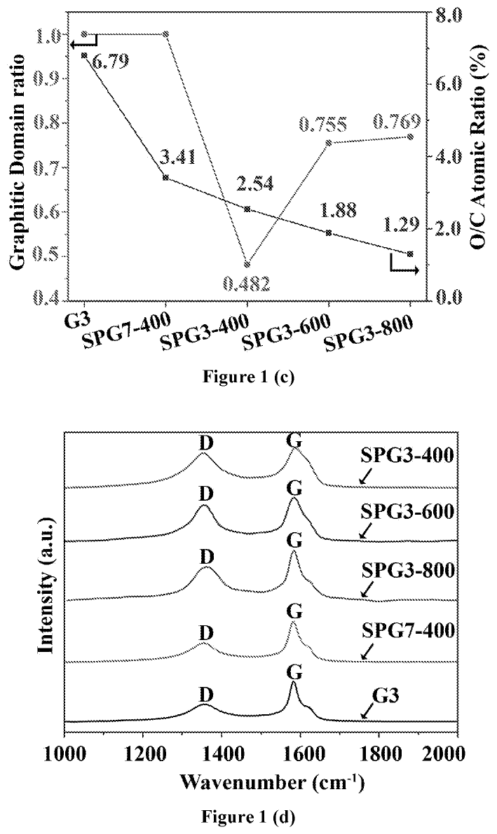

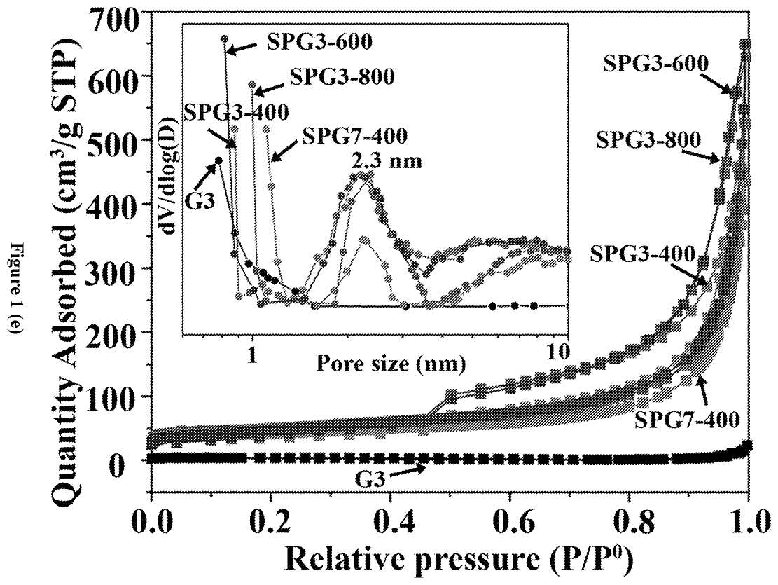

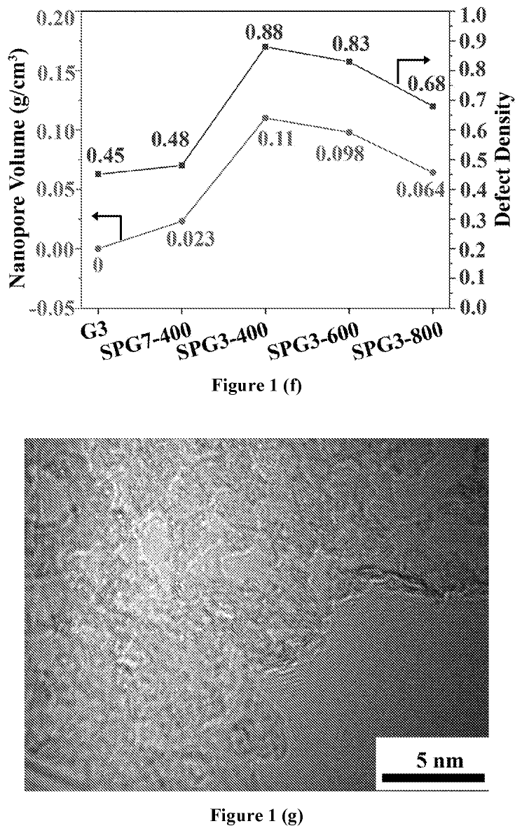

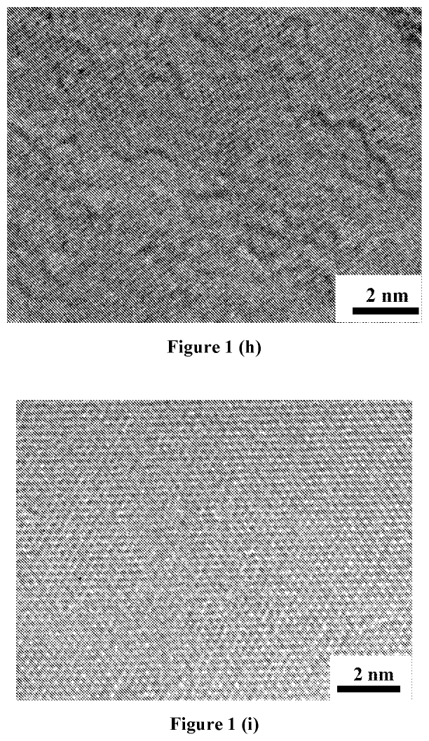

Analysis of the surface-perforated graphene prepared by the methods described herein retain the thin film and few-layer structure from the original few-layer graphene. The SPG exhibits partial expansion of interlayer spacing, as evidenced by wide-angle X-ray diffraction (XRD) analysis. XRD peaks are quoted with an error of 0.2° 2θ. Pristine three-layer graphene (G3) treated at 400° C. (G3-400) showed a narrow peak centred at ˜26.6° (d value of 3.35 Å, indexed to 002 diffraction). In comparison, SPG3-400 produced in accordance with the methods described herein exhibits a much broader peak with a main peak at ˜26.6° (P1) and two shoulder peaks at ˜25.74° (P2) and ˜24.75° (P3). The d values of P2 and P3 are calculated to be 3.46 Å and 3.60 Å, respectively. See the XRD data in FIG. 1b. This indicates that the layered lattice fringes are partially expanded (˜3.50-3.60 Å) as evidenced from lattice fringe line-scan intensity profile analysis. See the TEM data in FIG. 1a and the line scan of FIG. 5.

Accordingly, the present invention also provides SPG characterised by a wide-angle X-ray diffraction (XRD) profile comprising at least one shoulder peak at less than 26°2θ. In some embodiments, the XRD profile comprises two shoulder peaks at less than 26.0°2θ. In some embodiments, the XRD profile comprises two shoulder peaks at about 25.74 and about 24.75°2θ±0.2°2θ. In some embodiments, the XRD demonstrates two shoulder peaks at less than 26° with >20% areal ratio. In a preferred embodiment, the XRD profile comprises two shoulder peaks at about 25.74 and about 24.75°2θ said shoulder peaks comprising a greater than 20% areal ratio.

The SPG comprises a greater than 50% expanded layer lattice when compared to the pristine graphene precursor or starting material. Typically, the expansion interlayer distance is greater than 3.40 Å, for example greater than 3.46 Å or greater than 3.5 Å. In some embodiments, the SPG has a greater than 50% expanded lattice with an expansion interlayer distance of greater than 3.40 Å or greater than 3.46 Å, for example from about 3.40 Å to about 3.70 Å, or about 3.40 Å to about 3.60 Å, or about 3.40 Å to about 3.50 Å.

As shown in FIG. 1e, the SPG exhibits in-plane nanopores or nanoporous defects with dimensions of from about 1.5 nm to about 3.5 nm. In some embodiments, the nanopores have dimensions of from about 2.0 to about 2.5 nm, for example with an average of about 2.3 nm, or about 2.3 nm.

As illustrated by FIG. 1c, the SPG of the invention comprises a low O/C ratio of less than 4%, or less than 3%. In some embodiments, the O/C ratio is about 2% to about 3%, for example about 2.3% to about 2.7%, such as about 2.54%.

In an embodiment, the surfactant-assisted thermal perforation technology described herein provides surface-perforated three-layer graphene (SPG3-400), with a high content (about 50%) of expanded layers with the interlayer distance larger than about 3.46 Å, a significant amount of in-plane nanoporous defects of about 2.3 nm, and an extremely low O/C ratio of about 2.54%.

It will be understood that the graphene may be further processed in accordance with the requirements of its intended use. For example the graphene may be further processed to form a cathode.

Methods of further processing graphene are well known in the art. In particular, a graphene cathode may be prepared from the SPG using well-known literature methodology for preparing graphene cathodes, such as those described in the examples below.

### Methods of Use

The processed graphene in accordance with the present invention exhibits advantageous properties and may be used in accordance with methods and apparatus well known in the art for application of graphene.

Although it is considered that the graphene can be used in any applications where conventional graphene is typically employed, the properties of the SPG described herein advantageously find application in battery technology. In particular, the SPG finds application in the manufacture of cathodes, particularly for use in rechargeable batteries, for example in aluminium-ion battery technology.

SPG prepared by the methods described herein can also find application as electro-adsorption materials in capacitive deionization applications.

The inventors have discovered that, for example, when SPG3-400 is used to form a cathode in a SPG3-400/Al battery, there is exhibited a reversible capacity of 197 mAh g⁻¹ at 2 Åg⁻¹ and a good high-rate performance (149 mAh g⁻¹ at 5 Åg⁻¹). This surpasses the performance of previously reported AIBs using graphitic carbon cathodes.

Accordingly, the present disclosure provides cathodes comprising processed graphene in accordance with the present invention. The present disclosure further provides batteries comprising processed graphene in accordance with the present invention, such as batteries comprising cathodes comprising processed graphene in accordance with the present invention.

In some embodiments, such cathodes comprise a carbon material comprising graphene processed in accordance with the present invention, a binder and a cathode substrate.

Any suitable binder may be used. In some particular embodiments, the binder is selected from carboxymethyl cellulose, polyvinylidene fluoride, polyvinylidene difluoride, polytetrafluoroethylene and polystyrene.

The carbon material present in the cathode may further comprise one or more additional carbon materials in addition to the graphene processed in accordance with the present invention. Suitable carbon materials include, example, graphene from gas, graphene from graphite, graphene oxide from graphite, graphite, modified carbon and carbon black.

In some embodiments, one or more of the carbon materials (i.e. the processed graphene/graphene processed in accordance with the present invention and/or any further carbon materials) are present in the form of carbon flakes, for example carbon flakes having a thickness of from about 1 nanometer up to about 30 micrometers.

In some embodiments, the cathode further comprises a surfactant, emulsifier or dispersant. In some particular embodiments, the cathode comprises a hydrophilic non-ionic surfactant, for example of the general class of copolymers known as poloxamers. Exemplary brand names of suitable poloxamers suitable for use in the present invention include: Pluronic® F-127, Synperonic™ PE/F-127, Kolliphor® P 407 and Poloxalene.

The cathode comprises one or more cathode substrates. Any suitable cathode substrate may be used. Suitable cathode substrates include, but are not limited to, carbon cloth, carbon paper, molybdenum foil and titanium foil. Such cathode substrates are in addition to the one or more carbon materials discussed above.

In preparing the cathode, a solvent may be used. The solvent is typically removed (or substantially removed) by drying to prepare the cathode. In some embodiments, the one or more carbon materials are mixed with the binder and the solvent, and optionally the surfactant, emulsifier or dispersant, the mixture applied to the cathode substrate, and the mixture dried to remove solvent, such as substantially all solvent, to provide the cathode. Any suitable solvent may be used. In some particular embodiments, the solvent is selected from N-methyl-2-pyrrolidone, water, dihydrolevoglucosenone, one or more hydrocarbon solvents, and surfactant emulsions.

Batteries of the present disclosure, such as rechargeable batteries, such as aluminium-ion batteries, comprise a cathode, such as described above, and further comprise an anode. In some particular embodiments, the anode comprises aluminium foil, for example aluminium foil of 97 to 99.99% purity.

Batteries of the present disclosure typically further comprise one or more electrolytes, such as in the form of an electrolyte fluid. Suitable electrolytes include, but are not limited to, 1-ethyl-3⁻ methylimidazolium chloride-aluminum chloride ([EMIm]Cl-AlCl₃, 1:1.3 by mole); urea-AlCl₃; aluminum trifluoromethanesulfonate; (Al[TfO]3)/N-methylacetamide/urea; AlCl₃/acetamide; AlCl₃/N-methylurea; AlCl₃/1,3-dimethylurea; bistriflimide, systematically known as bis(trifluoromethane)sulfonylimide (or ‘imidate’) and colloquially as TFSI; and trifluoromethanesulfonate.

Batteries of the present disclosure typically further comprise a separator. Suitable separator materials include, but are not limited to, glass fibre, polytetrafluoroethylene or any synthetic fluoropolymer of tetrafluoroethylene, cellulose membrane and poly acrylonitrile.

Those skilled in the art will appreciate that the invention described herein is susceptible to variations and modifications other than those specifically described. It is to be understood that the invention includes all such variations and modifications which fall within the spirit and scope.

In order that the invention may be readily understood and put into practical effect, particular preferred embodiments will now be described by way of the following non-limiting examples.

### EXAMPLES

General

All commercial reagents and starting materials were used as received unless otherwise stated.

Preparation of Graphene nanosheets: Exfoliated graphene nanosheets with ˜3 and 7 layers were prepared by a previously reported electrochemical exfoliation method (Parvez, K.; Wu, Z.-S.; Li, R.; Liu, X.; Graf, R.; Feng, X.; Millen, K., Exfoliation of Graphite into Graphene in Aqueous Solutions of Inorganic Salts. Journal of the American Chemical Society 2014, 136 (16), 6083-6091) with slight modifications. The electrochemical exfoliation was performed in a two-electrode system using graphite foil (˜1 g) as the working electrode, titanium foil as the counter electrode and aqueous sodium sulphate (Na₂SO₄, 0.1 M, 200 mL) as the electrolyte. A positive voltage of 10 V was applied to the graphite electrode for two hours to enable the exfoliation process. The precipitate was collected by vacuum filtration, rinsed with deionised water (5 times) to remove residual salts, and then dispersed into isopropanol (IPA, 200 mL) by sonication. The obtained suspension was centrifuged at 1000 rpm for 10 minutes. The supernatant was collected and further filtered to obtain three-layer graphene (G3) nanosheets. The sediment was re-dispersed into 200 mL IPA by sonication, and then centrifuged at 200 rpm for 10 minutes to remove unexfoliated graphite and thick graphene sheets. The resultant supernatant was filtered to obtain seven-layer graphene (G7) nanosheets.

Thermal reductive perforation of graphene: Typically, G3 nanosheets (150 mg) were dispersed into deionised water (30 mL) containing Pluronic F127 (360 mg) and sonicated for 1.5 hours to obtain a stable suspension. Then the suspension was transferred into a glass culture dish for solvent evaporation at room temperature. The dried solid was calcined at 400° C. with a heating rate of 2° C. min¹ under argon flow to produce SPG3-400. SPG7-400 was synthesized through the same procedure by using G7 as the precursor.

Materials characterization: The morphology and structure of materials were examined by transmission electron microscopy (TEM) using a HF-7700 microscope operated at 80 kV. X-ray diffraction (XRD) patterns were obtained by a Bruker X-ray Powder Diffractometer (D8 Advance, λ=1.5406 Å). Raman spectra were measured on a Renishaw Raman spectrometer using Ar laser with the wavelength of 514 nm. Nitrogen (N₂) adsorption/desorption isotherms were measured using a Micromeritics ASAP TristarII 3020 system. The samples were degassed under vacuum at 200° C. for >8 hours. The pore size distribution was determined by the Barrett-Joyner-Halenda (BJH) method using adsorption branches. Atomic force microscopy (AFM) images were taken by an Asylum Research Cypher AFM under ambient conditions. Thermogravimetric analysis (TGA) measurements were performed by a TGA/DSC 1 Thermogravimetric Analyzer (Mettler Toledo Inc) with a heating rate of 5° C. min¹ under nitrogen (N₂) flow. X-ray photoelectron spectroscopy (XPS) spectra were measured by a Kratos Axis ULTRA X-ray photoelectron spectrometer. The atomic concentration calculation and peak shifting of XPS results were processed by the Casa XPS version 2.3.14 software.

Typical transmission electron microscope (TEM) images of SPG3-400 show that this material inherits the thin film and three-layer structure from G3 (FIG. 1a and the inset). The layered lattice fringes are partially expanded (˜3.50-3.60 Å) as evidenced from the lattice fringe line-scan intensity profile analysis (FIG. 5). The partial interlayer spacing expanding is supported by wide-angle X-ray diffraction (XRD) analysis. As shown in FIG. 1b, pristine G3 treated at 400° C. (G3-400) showed a narrow peak centred at ˜26.6° (d value of 3.35 Å, indexed to 002 diffraction). For SPG3-400, a much broader peak was observed with a main peak at ˜26.6° (P1) and two shoulder peaks at ˜25.74° (P2) and ˜24.75° (P3). The d values of P2 and P3 are calculated to be 3.46 Å and 3.60 Å, respectively. Both TEM and XRD results have shown that SPG3-400 after the TRP treatment possesses both highly crystalline and expanded layer lattices.

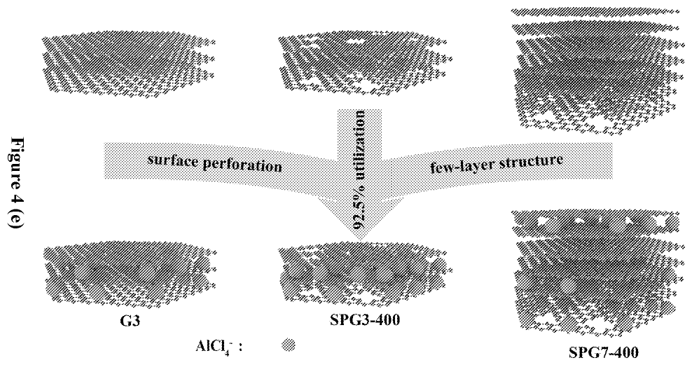

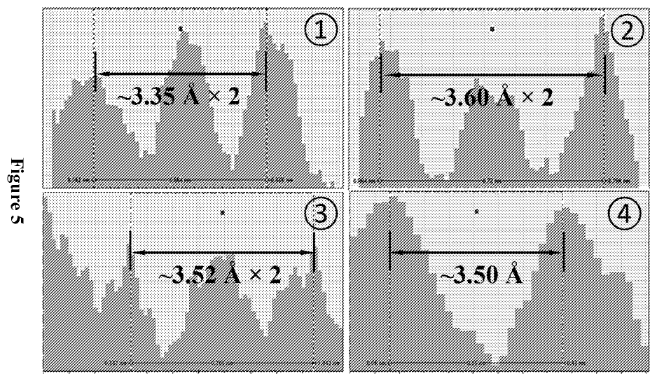

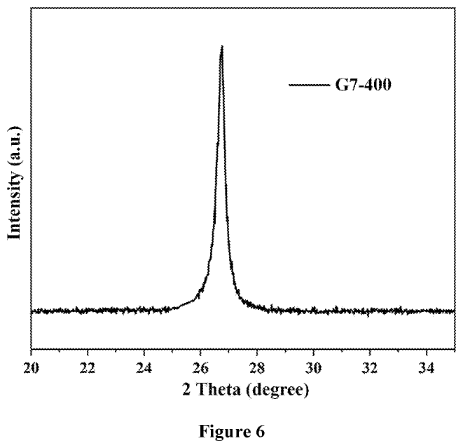

To investigate the impact of calcination temperature and layer number of graphene nanosheets on the structure and performance of SPG materials prepared via the TRP strategy, control experiments were conducted. For SPG3-600 and SPG3-800 treated at 600 and 800° C., respectively, XRD analyses indicate that the intensity of P2 and P3 shoulder peaks decreases compared with SPG3-400, suggesting that the expanded layer lattices undergo thermal recovery at elevated temperature. SPG7-400 was also prepared by the same TRP treatment as SPG3-400, but using seven-layer graphene (G7) nanosheets as the precursor. The XRD pattern of SPG7-400 exhibits a sharp diffraction peak at ˜26.6° with negligible difference comparing to pristine G7-400 (FIG. 6), indicating that the TRP process mainly affects surface layers and the choice of G3 nanosheets is advantageous in generating a higher portion of expanded interlayer spacing than G7. By calculating the area of deconvoluted peaks (P1, P2, P3), the graphitic domain ratio [P1/(P1+P2+P3)] of tested materials is presented in FIG. 1c. Both G3-400 and SPG7-400 have predominant graphitic domains. SPG3-400,-600 and -800 have graphitic domain ratios of 0.482, 0.755 and 0.769, respectively. Over 50% of the layer lattices of SPG3-400 have been expanded, which is higher compared to previously known graphenes.

Lattice expansion has previously been reported in reduced graphene oxide produced from graphite using chemical oxidation routes, however this usually leads to increased O/C ratios. However, X-ray photoelectron spectroscopy (XPS) analysis results show that the TRP process decreased the atomic O/C ratio from 17.5% (pristine G3) to 2.54, 1.88 and 1.29% for SPG3-400, SPG3-600 and SPG-800, respectively (FIG. 1c). The low O/C ratios in SPG materials are comparable to that (1.84%) of graphene materials annealed at ultra-high temperature (˜3000° C.), indicating that the TRP strategy is effective in significantly reducing the residual oxygen at moderate thermal treatment conditions.

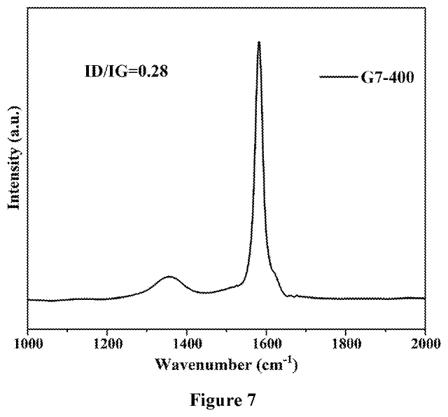

Raman spectroscopy and N₂ adsorption/desorption measurements were employed to further examine the structure of SPG materials (FIG. 1d, 1e and FIG. 7). Typical D and G bands peaking at ˜1355 and ˜1582 cm-1 can be observed in the Raman spectra of all samples, from which the defect densities (the intensity ratio of D band to G band, I_{D}/I_{G}) were calculated and plotted in Figure if. The defect density increases from pristine G3-400 (0.45) and G7-400 (0.28, FIG. 7) to SPG3-400 (0.88) and SPG7-400 (0.48) after the TRP process, but decreases with increasing calcination temperature (600 and 800° C.) due to the partial restoration of sp² network, consistent with the XRD results. Compared to G3-400 with a relatively solid nature, the porous characteristics of SPG materials evidenced from their N₂ sorption isotherms and corresponding pore size distribution curves indicate the TRP process generates mesopores with a mean size of around 2.3 nm. The pore volumes corresponding to ˜2.3 nm mesopores are calculated and plotted in Figure if, showing a similar trend to the defect density calculated from Raman analysis. SPG3-400 has a mesopore (˜2.3 nm) volume of 0.11 g cm⁻³.

The XRD, Raman spectroscopy, XPS and nitrogen sorption analyses have shown that the TRP strategy has generated three-layer graphene with a high content (>50%) of expanded layers, a low O/C ratio and a significant amount of in-plane mesoporous defects. Dark-field HRTEM of SPG3-400 provides direct observations of in-plane mesopores on graphene surface, showing abundant nanopores of 2-3 nm (FIG. 1g). Aberration corrected TEM images of SPG3-400 and G3-400 are shown in FIG. 1h and Ii, respectively. While G3-400 exhibits well-crystalline graphitic lattice, the in-plane defects can be observed in the surface graphitic layer of SPG3-400, consistent with the mesopore and structural defect analysis.

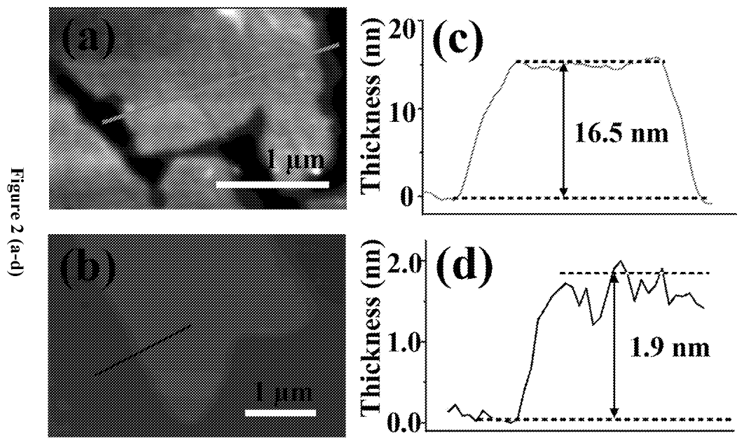

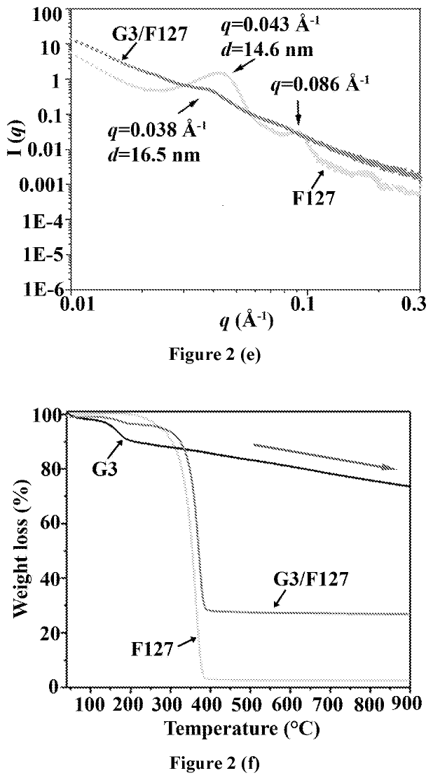

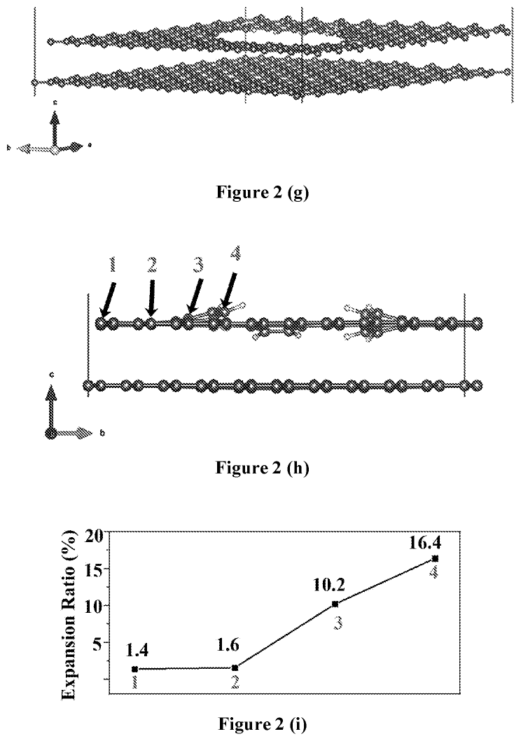

Morphology of the G3/F127 composite was investigated. Examination by atomic force microscopy (AFM) displays a typical nanosheet feature (FIG. 2a), similar to that of pristine G3 nanosheet (FIG. 2b). The height profile taken along the line demonstrates that G3/F127 composite nanosheet has an average thickness of ˜16.5 nm (FIG. 2c), which is significantly higher than pristine G3 of ˜1.9 nm (FIG. 2d), indicating a uniform coating of F127 on G3 surfaces. Small angle X-ray scattering (SAXS) patterns of G3/F127 composite and pure F127 were recorded (FIG. 2e). The SAXS pattern of pure F127 shows two well-resolved peaks (q values of 0.043 and 0.086 Å⁻¹) associated with a lamellar meso-structure (d value of 14.6 nm). For G3/F127 composite, only a broad peak with weak intensity at ˜0.038 Å⁻¹ was observed. It is believed that that the hydrophobic graphene basal plane can interact with the hydrophobic PPO segment and drag F127 onto its surface, and presumably F127 was coated onto both sides of G3 and formed a sandwich-like structure of G3/F127 composite.

The TRP process was also investigated by thermal gravimetric analysis (TGA) for G3/F127 composite in comparison with F127 and pristine G3 nanosheets (FIG. 2f). Pristine G3 experienced a slow and continuous weight loss even at 900° C. Pure F127 underwent a fast and complete decomposition in the temperature range from ˜250 to 380° C. with a residue less than 2%. For G3/F127 composite, the TGA curve shows a two-step weight loss profile. The first minor weight loss (˜2%) at ˜140-200° C. was mainly due to the dissociation of physiosorbed molecules (e.g., water), similar to that of pristine G3. The major weight loss step (˜69%) appeared at ˜300-400° C. with negligible further loss after 400° C., indicating that the thermal decomposition behaviour of G3 has been changed by F127 in the TRP process. From the differential thermogravimetric analysis, the F127 decomposition temperature for G3/F127 composite is ˜24° C. higher than that for pure F127, indicative of interaction between F127 and G3 nanosheets. The thermal decomposition of PPO and PEO is believed to proceed by homolytic cleavage of the C—O and C—C bonds and forms active radicals (•CHCH₃CH₂O—, —CH₂CH₃CHO•, •CH₂O—, etc). Graphene and reduced graphene oxide have capability to adsorb free radicals, both chemically and physically. High concentration free radicals may act as “scissors” to break C═C and C—O bonds suggesting that the thermal decomposition of F127 produces active radicals which are responsible for the surface perforation and oxygen depletion during the TRP process.

DFT simulation: Calculations were performed within density functional theory (DFT) as implemented in Vienna ab initio simulation package (VASP) (Kresse, G.; Furthmüller, J., Efficient iterative schemes for ab initio total-energy calculations using a plane-wave basis set. Phys. Rev. B 1996, 54 (16), 11169.; Kresse, G.; Furthmüller, J., Efficiency of ab-initio total energy calculations for metals and semiconductors using a plane-wave basis set. Comput. Mater. Sci. 1996, 6 (1), 15-5) with the interaction of ions and electrons being described by projector-augmented wave (PAW) method (Kresse, G.; Joubert, D., From ultrasoft pseudopotentials to the projector augmented-wave method. Phys. Rev. B 1999, 59 (3), 1758). The total energies were calculated the total energies within Perdew-Burke-Emzerhof (PBE) functional of generalized gradient approximation (GGA) (Perdew, J. P.; Burke, K.; Ernzerhof, M., Generalized gradient approximation made simple. Phys. Rev. Lett. 1996, 77 (18), 3865.

The cut-off energy was set to be 400 eV, and a 3×3×1 Gamma-centered K-mesh was used to sample the first Brillouin zone. The interlayer vdW interactions was considered by DFT-D3 correction (Grimme, S.; Antony, J.; Ehrlich, S.; Krieg, H., A consistent and accurate ab initio parametrization of density functional dispersion correction (DFT-D) for the 94 elements H—Pu. The Journal of chemical physics 2010, 132 (15), 154104). The geometric structures were optimized without any constraint until the energy of each atoms converged to 10⁻⁶ eV and the force of them was less than 0.001 eV/Å. The surface-perforated model was simulated by an AB-stacking bilayer graphene with the hole existing at the top surface. The size of the holes is around 10 Å to shield the interactions of two facing edges. The edge of hole is saturated by hydrogen atoms for possible connection of functionalized carbon groups, making carbon edges the completely sp³ hybridization.

In order to examine the influence of in-plane nanopores on graphene interlayer lattice structure, first-principle based DFT simulation was conducted using an AB-stacking graphene model with surface nanopore and edge saturated by hydrogen atoms (FIG. 2g). Comparing to an intact graphene model, carbon atoms near the nanopore deflect from the original lattice fringe due to weakened interlayer interaction (from sp² to sp³ hybridization), leading to expanded interlayer lattice (FIG. 2h), consistent with TEM and XRD observations (FIGS. 1a and 1b). The nearest carbon atom (4) to the nanopore shows a maximum interlayer expansion ratio of 16.4% (FIG. 2i), and this ratio decreases back to normal when the carbon position goes far from the pore edge (position 4 to 1). This suggests that creating abundant in-plane nanopores is beneficial for the formation of SPG3-400 with a high portion of expanded layers.

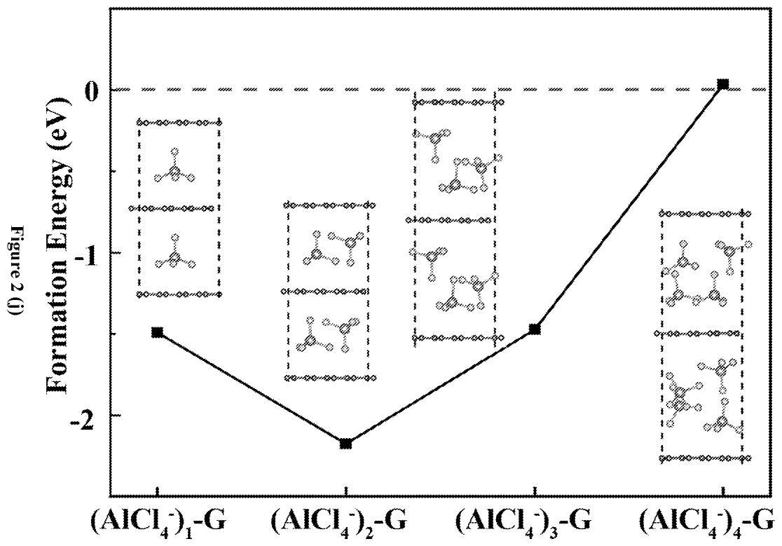

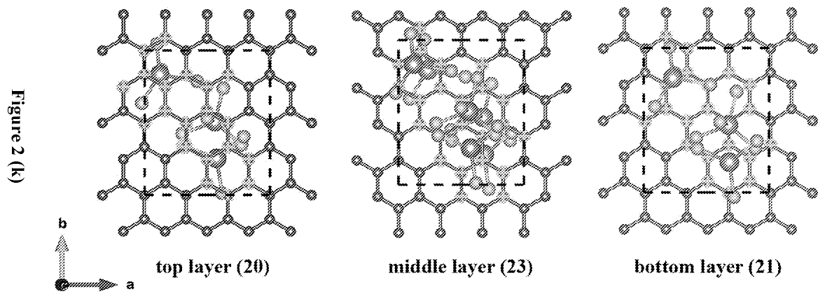

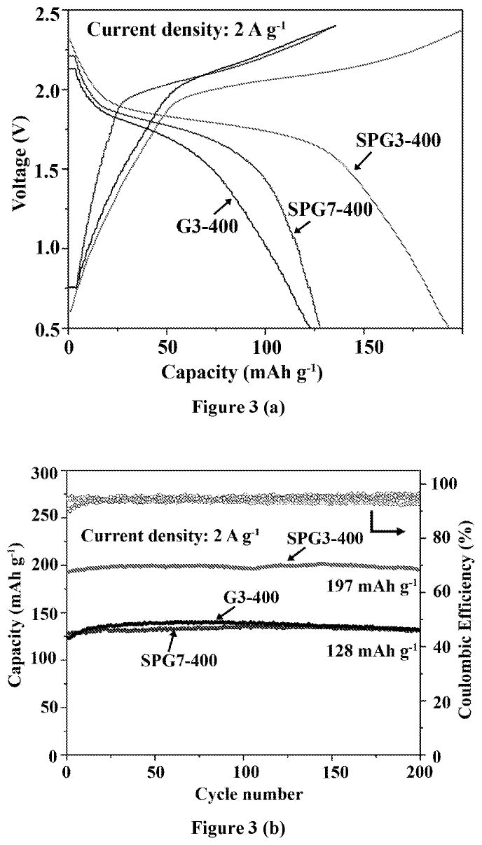

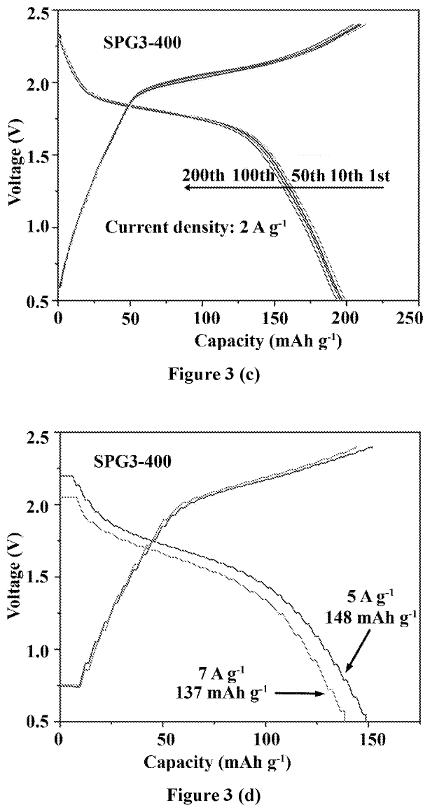

To estimate the maximum theoretical capacity of graphene materials, the intercalation of AlCl₄⁻¹ nto three-layer graphene (ABA stack) was studied via DFT calculation. A supercell of three-layer graphene with each layer containing 24 carbon atoms was used. The formation energies of graphene intercalation compounds at stage 1 intercalation (each graphene sheet is separated from the others by intercalant) with different numbers (x) of AlCl₄⁻ anion (denoted as (AlCl₄⁻)ₓ-G, x=1, 2, 3, 4) were calculated. The formation energy is defined as E_{f}=E[(AlCl₄⁻)ₓ-G]-E[(AlCl₄⁻)ₓ₋₁-G]-2E(AlCl₄⁻), where E[(AlCl₄⁻)ₓ-G] represents the total energy of graphene with xAlCl₄⁻ intercalation for each interlayer spacing and E(AlCl₄⁻) is the energy of single AlCl₄⁻ anion. The (AlCl₄⁻)ₓ-G structures at all x points and their corresponding formation energies are shown in FIG. 3j. (AlCl₄⁻)₁-G, (AlCl₄⁻)₂-G and (AlCl₄⁻)₃-G turned out to be all thermodynamically stable except x increased to 4. The maximum theoretical capacity was estimated using (AlCl₄⁻)₃-G as the most favourable configuration and counting the number of carbon atoms of which the electron cloud is overlapped with AlCl₄⁻ anion⁴¹. (AlCl₄⁻)₃-G was found to deliver an average specific capacity of ˜213 mAh g⁻¹, corresponding to one AlCl₄⁻ anion per 10-11 carbon atoms.

Electrochemical measurements: Battery performance tests were conducted using standard CR2032-type coin cells modified with poly(3,4-ethylenedioxythiophene) (PEDOT) coating. The working cathodes were prepared by casting the slurry of synthesized graphene materials, carbon black and Nafion binder at a weight ratio of 80:10:10 onto carbon cloth substrates, followed by drying under vacuum at 80° C. for ˜12 hours. The mass loading of the active material was approximately 1.5-2.0 mg cm². Pure Al foil was used as the anode. Filtech glass fiber was used as the separator. The electrolyte was 1-ethyl-3⁻ methylimidazolium chloride-aluminium chloride ([EMIm]Cl-AlCl₃, 1:1.3 by mole). The cells were assembled in an Ar-filled glove box. The batteries were firstly charged to 2.4 V and then discharged to a cut-off voltage of 0.5 V to prevent the decomposition of electrolyte.

At the current density of 2 Åg⁻¹, SPG3-400 delivered the typical high discharge voltage profile of graphitic cathodes with the plateau at 1.7-1.9 V (FIG. 3a) with a high specific discharge capacity of 197 mAh g⁻¹, surpassing all reported graphitic cathodes at the same current (Table S1). This experimental value reached 92% of the theoretical capacity value, suggesting efficient utilization of graphene interlayer space for AlCl₄⁻ storage. After 200 charge-discharge cycles, the discharge capacity was well maintained without obvious decay (FIG. 3b) nor voltage polarisation (FIG. 3c), indicating excellent electrochemical stability of SPG3-400. In contrast, G3-400 exhibited a lower initial capacity of 124 mAh g⁻¹ over 200 cycles, demonstrating the importance of the TRP design. Other control materials including SPG7-400 and G7-400 with thicker layers were also tested (FIGS. 3a and b). SPG7-400 showed a discharge capacity of 128 mAh g⁻¹, inferior to that of SPG3-400, but still largely improved from 93 mAh g⁻¹ of G7-400, validating the concept of few-layer and surface perforation for improving AlCl₄ storage capability. Notably, the capacity improvement from G3-400 to SPG3-400 (73 mAh g⁻¹) is more than two times higher than that for G7-400 and SPG7-400 (35 mAh g⁻¹), suggesting a synergetic effect of TRP strategy in few-layer graphene for releasing their ion storage potential.

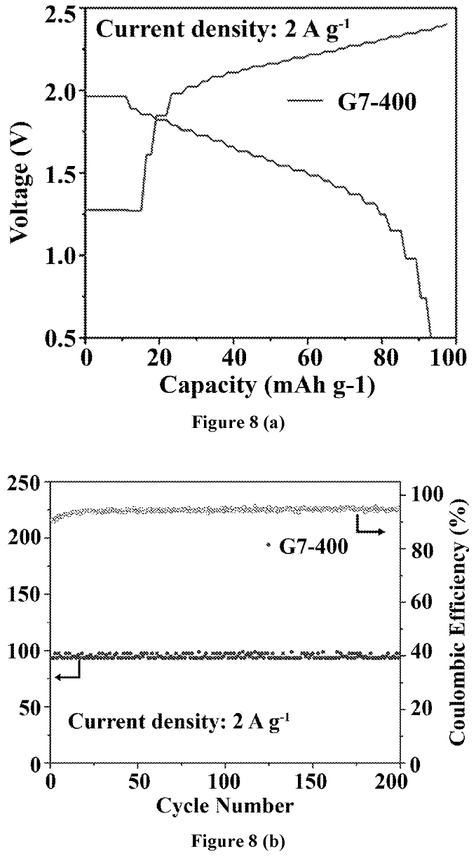

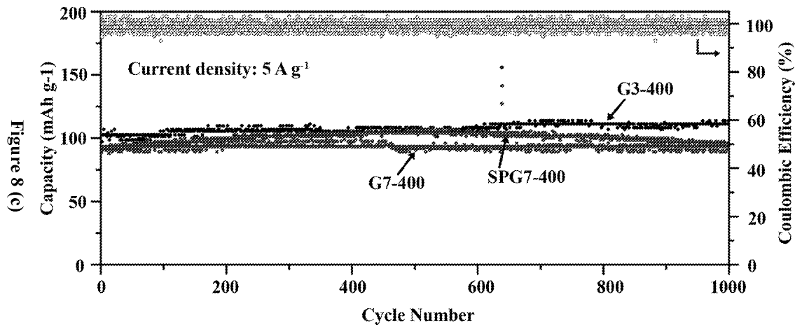

At high current densities of 5 Åg⁻¹ and 7 Åg⁻¹, SPG3-400 still delivered high reversible capacities (149 and 138 mAh g⁻¹, respectively) with clear charge/discharge plateaus (FIG. 3d), suggesting the rapid anion intercalation processes in SPG3-400 lattice rather than an adsorption/desorption based electrochemical capacitive mechanism. The relatively shortened charge and discharge plateaus at 5 A g⁻¹ and 7 A g⁻¹ can be attributed to the slightly polarization caused by the high charge/discharge rates. Furthermore, long-term cycling tests were conducted at high current rate 5 Åg⁻¹ to demonstrate the cycling stability of SPG3-400 cathode (FIG. 3e). SPG3-400 maintained the highest capacity of 147 mAh g⁻¹ at 5 A g⁻¹ after 1000 cycles, superior to all control cathodes (SPG7-400:96 mAh g⁻¹, G3-400:111 mAh g⁻¹ and G7-400:93 mAh g⁻¹, FIG. 8). Furthermore, long cycling tests were extended to 2000 cycles at higher current rate of 7 Åg⁻¹. As shown in FIG. 3e, SPG3-400 exhibits excellent cycling stability and achieves a reversible capacity of 128 mAh g⁻¹ after another 1000 cycles. These high-rate electrochemical performances demonstrated that the TRP strategy can improve both the storage capability and ion diffusivity of graphene cathodes toward bulky AlCl₄⁻ anions.

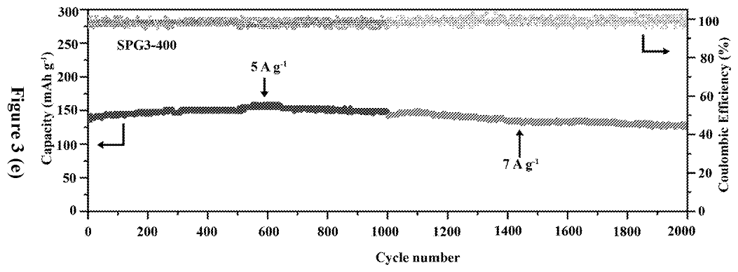

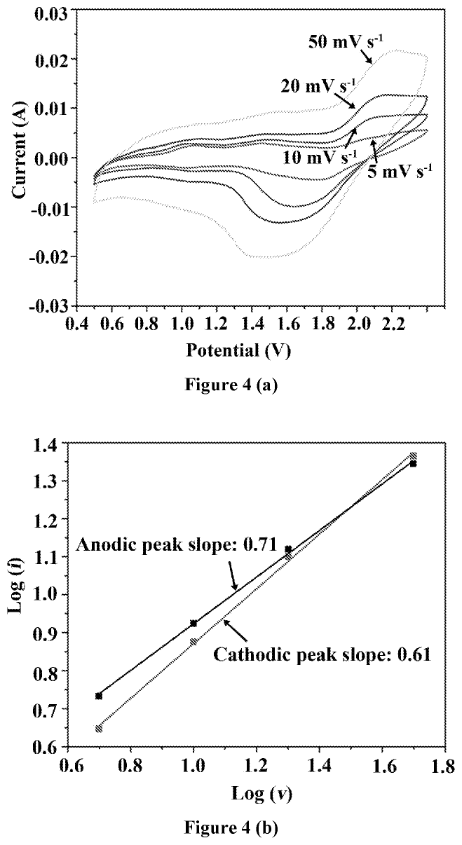

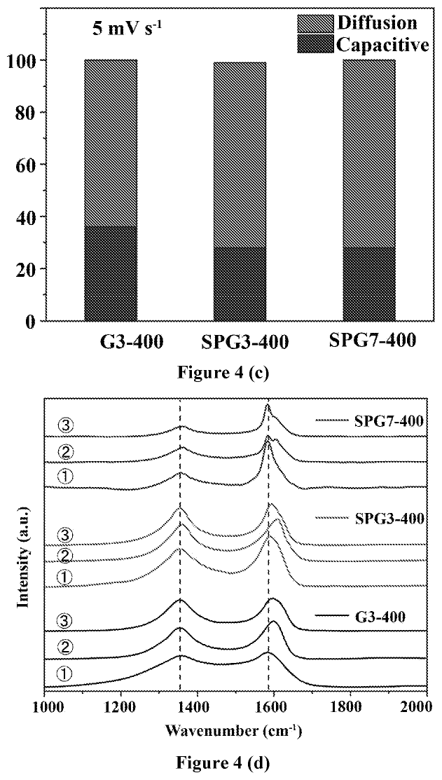

The electrochemical kinetics of SPG3-400 cathode in AIBs was investigated by cyclic voltammetry (CV). The CV curves of a typical SPG3-400 cathode (FIG. 4a) show anodic peak at ˜2.0-2.2 V and cathodic peak at ˜1.5-1.9 V, consistent with its charge/discharge curve in FIG. 3a. The CV scanning results (peak current i and scan rate v) were analysed using the power law equation (Equation 1):

i=α×v^{b} (1),
in which a and b are adjustable parameters. The b parameter, determined by the log(i) to log(v) slope, is the key factor to indicate the amount of capacity contribution by diffusion faradaic process (b=0.5) and capacitive process (fast surface faradaic charge-transfer, b=1). SPG3-400 showed anodic and cathodic b values of 0.71 and 0.61 (FIG. 4b), suggesting a combination of both diffusion and capacitive capacity contributions. The capacity contribution from diffusion process and capacitive process at a fixed scan rate of 5 mV s⁻¹ can be quantitatively differentiated based on their dependence on the scan rate (capacitive contribution: k₁×v, diffusion contribution: k₂×v^{1/2}) in equation 2:

i(v)=k₁×v+k₂×v^{1/2} (2).

The constants k₁ and k₂ can be determined by plotting i(v)/v^{1/2} against v^{1/2}, which allow to quantify the capacitive and diffusion contributions. The capacity contribution ratios of these two processes for SPG3-400, G3-400 and SPG7-400 at scan rate of 5 mV s⁻¹ are summarized in FIG. 4c. The diffusion capacity dominates more than half of total capacity in all tested cathodes, demonstrating that the electrochemical reaction is dominantly diffusion-controlled intercalation process. Comparing with G3-400 cathode, SPG3-400 showed increased diffusion capacity, suggesting that the improved capacity is mostly originated from the enhancement of AlCl₄⁻ ion intercalation.

Ex-situ Raman studies during battery operation: For ex-situ Raman, batteries were stopped at either fully charged or fully discharged states (2 Åg⁻¹), and disassembled in an Ar-filled glovebox. The cathode materials were carefully removed from carbon cloth substrates, and placed on glass slides with coverslips. To avoid reactions between the cathode and air/moisture in the ambient atmosphere, the covered glass slides were carefully sealed with parafilm and tapes, and the Raman measurements were conducted immediately after taking specimens out of the glove box.

Ex-situ Raman studies were performed to probe AlCl₄⁻¹ on intercalation/de-intercalation within cathode during battery operation. All measurements were conducted after the graphene cathodes reaching a stable capacity at the current rate of 2 Åg⁻¹, followed by battery disassembly in the Ar-filled glovebox. The obtained cathodes were rinsed with high-purity methanol for three times and sealed by coverslips for the following Raman analyses. As presented in FIG. 4d, G3-400, SPG3-400 and SPG7-400 display two main bands as D and G band for carbon in disordered and E_{2g} vibration mode, respectively. The G band of the SPG3-400 cathode was upshifted by ˜20 cm¹ (from 1589 to 1609 cm⁻¹) at fully charged state. This new band can be assigned as the vibrational mode of the boundary graphene layers (E_{2g(b)}) adjacent to intercalant layers. During the formation of the graphite intercalation compounds (GICs), the G band usually splits into doublet, giving rise to two E_{2g} vibration modes, E_{2g(b)} and E_{2g(i)} corresponding to the vibrational mode of inner graphene layers adjacent to other graphene. At fully charged state, the Raman spectrum of SPG3-400 cathode displayed a single E_{2g(b)} band, suggesting the formation of stage 1 or stage 2 GICs. The Raman spectrum in the subsequent fully discharged state is mostly reversible, corresponding to the de-intercalation of AlCl₄⁻¹ ons. G3-400 exhibited the same stage number as SPG3-400 due to the same three-layer feature. However, a smaller blue shift (13 cm⁻¹) was observed at fully charged state, indicating less intercalated guest AlCl₄⁻. For SPG7-400, the G bands were split into doublet upon anion intercalation (E_{2g(i)}: 1584 cm⁻¹, E_{2g(b)}: 1604 cm⁻¹), different from that of SPG3-400.

Based on the intensities of E_{2g(i)}/E_{2g(b)} bands, the intercalation stage was calculated using the following equation (equation 3):

$$\frac{{I}_{i}}{{I}_{b}} = \frac{{σ}_{i} ( n - 2 )}{{σ}_{b} 2} , \qquad ( 3 )$$

in which

$$\frac{{σ}_{i}}{{σ}_{b}}$$

is the ratio of Raman scattering cross-sections (considered to be unity), and n represents the stage number. The n value is calculated to be 4 for SPG7-400, consistent with that for graphite or graphene cathode in previous studies. The stage number indicates how many graphene layers are in between two intercalant layers. For SPG3-400, the stage number 1 or 2 GIC was found, suggesting that almost each graphene layer is occupied by AlCl₄⁻¹ ntercalants to give a capacity reaching 92% of the theoretical value. Finally, we summarized the working mechanism of SPG3-400 cathode in the scheme displayed in FIG. 4e. On the anode side, Al and AlCl⁴⁻ are converted into A₂Cl₇⁻ during the discharging, and the reverse reaction takes place during charging. On the cathode side, AlCl₄⁻¹ ons are intercalated and de-intercalated into graphene layers through both edges and basal planes during charge and discharge reactions, respectively.

Alternative exfoliation methods for the preparation of graphene nanosheets: Whilst the above Examples employ graphene nanosheets prepared from graphite foil using electrochemical exfoliation, other exfoliation methods for the preparation of few-layer graphene were also investigated, as detailed below.

Liquid-phase exfoliation: Liquid-phase exfoliation of graphite to prepare few-layer graphene was performed by a reported protocol (Coleman, J. N., Scalable Production of Large Quantities of Defect-free Few-layer Graphene by Shear Exfoliation in Liquids, Nature Materials 2014, 13, 624-630.) with slight modifications (solvent: N,N-dimethylformamide,N-methyl-2-pyrrolidone, concentration: 50 mg/ml, mixing speed: 5000 rpm, mixing time: 30-60 mins). In atypical synthesis, graphite was dispersed in exfoliation solvents (N,N-dimethylformamide,N-methyl-2-pyrrolidone, isopropanol, aqueous surfactant (quaternary ammonium surfactant, poly(alkylene oxide), sodium cholate, organosulfate surfactant) solutions) in a concentration of (1-100 mg/ml). A rotor mixer was used to mix the suspension at the speed of 1000 to 10000 rpm for 5-500 minutes. After mixing, the resultant dispersions were centrifuged (1000 rpm, 10 min) to remove unexfoliated graphite, and the supernatant collected were filtrated to obtain the few-layer graphene.

Mechanical exfoliation: The mechanical exfoliation of graphite to produce few-layer graphene was performed using the reported ball-milling method (Weifeng Zhao, Ming Fang, Furong Wu, Hang Wu, Liwei Wang and Guohua Chen, Preparation of graphene by exfoliation of graphite using wet ball milling, Journal of Materials Chemistry, 2010, 20, 5817-5819) with slight modifications (concentration 5 mg/ml, milling speed 300 rpm, 6 hours). Typically, graphite was dispersed in exfoliation solvents (N-methyl-2-pyrrolidone, N,N-dimethylformamide) at concentrations of 0.25-50 mg ml⁻¹, and then milled at 200-400 rpm for 6-24 hours. After ball-milling, the resultant products were centrifuged (1000 rpm, 10 min) to remove unexfoliated graphite, the supernatant collected were filtrated and washed by ethanol and water (3 times respectively) to obtain the few-layer graphene.

Chemical oxidative exfoliation: Chemical oxidative exfoliation was performed by Hummers' method (William S. Hummers Jr. and Richard E. Offeman, Preparation of Graphitic Oxide, Journal of the American Chemical Society 1958, 80, 6, 1339), modified such that the reaction was carried out for 3 days whilst stirring at room temperature. Typically, graphite flakes (5 g) were dispersed into H₂SO₄ (98%, 200 mL) for 1 h with ice/water bath cooling. Then, KMnO₄ (30 g) was added very slowly into the suspension with stirring. After 3 days stirring at room temperature, the mixture was slowly diluted into distilled water (2 L) and kept stirring for another 12 h. H₂O₂ (30% ˜20 mL) was then added dropwise to dissolve insoluble manganese oxides. Graphene oxide was obtained by centrifugation (4700 rpm, 30 min) and then washed with distilled water (4 times). The as-made graphene oxide was dried in 40° C. vacuum oven. The final step was the reduction of these graphene oxide chemically or thermally to obtain few-layer graphene.

The thermal reduction perforation process described herein can be used to prepare high performance graphene for use in, for example, cathodes for AIBs. The surface-perforated few-layer graphene (e.g. SPG3-400) has a high content (˜50%) of expanded layer lattice, a significant amount of in-plane nanopores (˜2.3 nm), and a low O/C ratio of 2.54%. This material exhibits an excellent reversible capacity (197 mAh g⁻¹ at 2 Åg⁻¹) and high-rate performance (149 mAh g⁻¹ at 5 Åg⁻¹), surpassing known AIBs using graphitic carbon cathodes. Without being bound by theory or mode of operation, it is believed that the high capacity of a cathode can be attributed to in-plane nanopores providing more accessible sites for AlCl₄⁻ storage; partially expanded lattice structure decreasing the AlCl₄⁻ ion diffusion barrier; low oxygen content eliminating surface adsorption behavior; and/or the few-layer feature allowing high utilization of interlayer spaces. This graphene material is considered useful in the development of AIBs, and also has the potential to be applied in other rechargeable battery systems.

The disclosure of every patent, patent application, and publication cited herein is hereby incorporated herein by reference in its entirety.

The citation of any reference herein should not be construed as an admission that such reference is available as “Prior Art” to the instant application.

Throughout the specification the aim has been to describe the preferred embodiments of the invention without limiting the invention to any one embodiment or specific collection of features. Those of skill in the art will therefore appreciate that, in light of the instant disclosure, various modifications and changes can be made in the particular embodiments exemplified without departing from the scope of the present invention. All such modifications and changes are intended to be included within the scope of the appended claims.

1. A method of processing graphene comprising the steps of:
combining few-layer graphene with a poly(alkylene oxide);
drying to form a graphene/poly(alkylene oxide) composite; and
calcining the graphene/poly(alkylene oxide) composite thus formed in an inert atmosphere.

2. The method according to claim 1, wherein the graphene is three-layer graphene.

3. The method according to claim 1, wherein the calcining temperature is from about 300° C. to about 500° C., preferably about 400° C.

4. The method according to claim 1, wherein the poly(alkylene oxide) is a block co-polymer, such as a poloxamer.

5. Processed graphene, preferably surface-perforated graphene, produced by, obtained by or obtainable by a process according to claim 1.

6. Processed graphene wherein the X-ray diffraction (XRD) profile demonstrates at least one shoulder peak, preferably two shoulder peaks, at less than 26.0°2θ.

7. The graphene according to claim 6, wherein the XRD profile demonstrates two shoulder peaks at less than 26.0°2θ with a greater than 20% areal ratio.

8. Processed graphene comprising a few-layer feature, preferably a three-layer feature, wherein the graphene further comprises one or more features selected from:
in-plane nanopores with dimensions of from about 1.5 nm to about 3.5 nm;
a greater than 50% expanded interlayer lattice;
an expansion interlayer distance of greater than 3.40 Å; and
an atomic O/C content of less than 4%.

9. A cathode comprising graphene according to claim 5.

10. The cathode according to claim 9, comprising a carbon material comprising graphene, a binder and a cathode substrate.

11. The cathode according to claim 10, wherein the cathode substrate is selected from carbon cloth, carbon paper, molybdenum foil and titanium foil.

12. The cathode according to claim 10, wherein the binder is selected from carboxymethyl cellulose, polyvinylidene fluoride, polyvinylidene difluoride, polytetrafluoroethylene and polystyrene.

13. The cathode according to claim 10, further comprising a surfactant, emulsifier or dispersant.

14. The cathode according to claim 13, wherein the surfactant, emulsifier or dispersant comprises a hydrophilic non-ionic surfactant.

15. The cathode according to claim 14, wherein hydrophilic non-ionic surfactant comprises a poloxamer.

16. The cathode according to claim 10, comprising one or more further carbon materials in addition to the graphene.

17. The cathode according to claim 16, wherein the one or more further carbon materials is selected from graphene from gas, graphene from graphite, graphene oxide from graphite, graphite, modified carbon and carbon black.

18. The cathode according to claim 10, wherein one or more of the carbon materials is present in the form of carbon flakes having a thickness of from about 1 nanometer to about 30 micrometers.

19. A process for preparing a cathode according to claim 9, comprising: mixing one or more carbon materials including graphene with a binder, a solvent and optionally a surfactant, emulsifier or dispersant; applying the mixture to a cathode substrate; and drying the mixture to remove the solvent.

20. The process according to claim 19, wherein the solvent is selected from N-methyl-2-pyrrolidone, water, dihydrolevoglucosenone, one or more hydrocarbon solvents, and surfactant emulsions.

21. A cathode obtained by the process according to claim 19.

22. A rechargeable battery comprising graphene according to claim 5 or a cathode.

23. An aluminium-ion battery comprising graphene according to claim 5 or a cathode.

24. The battery according to claim 22, further comprising an anode, wherein the anode comprises aluminium foil.

25. The battery according to claim 22, further comprising one or more electrolytes, wherein the one or more electrolytes comprise 1-ethyl-3⁻ methylimidazolium chloride-aluminum chloride ([EMIm]Cl—AlCl₃); urea-AlCl₃; aluminum trifluoromethanesulfonate; (Al[TfO]3)/N-methylacetamide/urea; AlCl₃/acetamide; AlCl₃/N-methylurea; AlCl₃/1,3-dimethylurea; bistriflimide, systematically known as bis(trifluoromethane)sulfonylimide (or ‘imidate’) and colloquially as TFSI; and/or trifluoromethanesulfonate.

26. The battery according to claim 22, further comprising a separator, wherein the separator comprises a material selected from glass fibre, polytetrafluoroethylene or any synthetic fluoropolymer of tetrafluoroethylene, cellulose membrane and poly acrylonitrile.

27. A use of processed graphene according to claim 5 in a capacitive deionization application or in a rechargeable battery application.
